(19) United States
(12) Patent Application Publication
(10) Pub. No.: US 2008/0276999 A1
(43) Pub. Date: Nov. 13, 2008

(54) FLUID FILTER AND DRAIN VALVE BODY THEREOF

(75) Inventor: Yoshihiro OHASHI, Aichi-ken (JP)

Correspondence Address: GREENBLUM & BERNSTEIN, P.L.C., 1950 ROLAND CLARKE PLACE, RESTON, VA, 20191, US

(73) Assignee: TOYOTA BOSHOKU KABUSHIKI KAISHA, Aichi-ken (JP)

(21) Appl. No.: 12/042,600

(22) Filed: Mar. 5, 2008

(30) Foreign Application Priority Data
May 9, 2007 (JP) 2007-124990

(51) Int. Cl. F16K 24/00; B01D 27/08

(52) U.S. Cl. 137/588; 210/440

(57) ABSTRACT

The fluid filter includes a filter element, a tubular body that supports the filter element, a cap and a base that house the filter element and the tubular body and can be screwed together through relative rotation, a drain cap that is attached detachably to the cap from the outer side and closes a drain hole provided in the cap, and a drain valve body that is provided between the cap and the tubular body and sandwiches the tubular body together with the base. The drain valve body includes a valve portion that closes the drain hole openably, a biasing portion that extends from an end portion of the valve portion and biases the valve portion is a direction for closing the drain hole, and a latch portion that is provided on an end portion of the biasing portion and latched to a latched portion provided on the tubular body.

### BACKGROUND OF THE INVENTION

1. Field of the Invention

The present invention relates to a fluid filter such as an oil filter or a fuel filter for filtering foreign matter, such as wear particles and carbon, that intermixes with a fluid such as oil for lubricating an internal combustion engine, and a drain valve body thereof, and more particularly to a fluid filter and a drain valve body thereof with which reductions in the number of internally assembled components and the assembly time can be achieved.

2. Description of the Related Art

An element replacement-type fluid filter, in which a filter element can be replaced when the filter element reaches the end of its life after a predetermined time period, is known as an example of a typical conventional fluid filter.

When the filter element, a sealing member and so on are replaced in the element replacement-type fluid filter, oil is discharged through a drain hole before separating a base and a cap by releasing the engagement between these members (see Patent Document 1, for example). A drain mechanism of this type of fluid filter includes a drain cap that is attached to the cap detachably from the outer side and closes the drain hole, a valve member that is provided on the inside of the cap and closes the drain hole, and a coil spring that biases the valve member in a direction for closing the drain hole.

To discharge the oil using the drain mechanism constituted in this manner, first the drain cap is detached from the cap such that closure of the drain hole by the drain cap is released. Next, a tubular drain jig is inserted into the drain hole to displace the valve member against the biasing force of the coil spring such that closure of the drain hole by the valve member is released. Next, the fluid in the interior of a casing is discharged to the outside through a drain passage provided in the drain jig.

According to the drain mechanism for a fluid filter described above, fluid discharge can be performed using the tubular drain jig when the filter element and so on are to be replaced, and therefore a situation in which the fluid spills out from the fluid filter during fluid discharge so as to contaminate the surrounding area can be avoided.

Patent Document 1: Japanese Patent Application Publication No. JP-A-2004-160348

### SUMMARY OF THE INVENTION

[Problems to be Solved by the Invention]

However, in the drain mechanism for a fluid filter described in Patent Document 1, the valve member that is provided in the interior of the cap and serves as a closing member for closing the drain hole and the coil spring that serves as a biasing member for biasing the valve member in a direction for closing the drain hole are provided as separate structures, leading to an increase in the number of components and a corresponding increase in cost. Furthermore, the valve member and coil spring must be assembled every time during manufacturing the filter, or replacing the filter element, sealing member and so on are replaced, and since the assembly operation is complicated, it requires a large amount of time.

An object of the present invention is to provide a fluid filter and a drain valve body thereof with which reductions in the number of internally assembled components and the assembly time can be achieved.

[Means for Solving Problem]
1. A drain valve body for a fluid filter, provided in a fluid filter having a filter element, a tubular body that supports the filter element, a cap and a base that house the filter element and the tubular body and can be screwed together through relative rotation, and a drain cap that is attached detachably to the cap from an outer side and closes a drain hole formed in the cap, the drain valve body comprising:

a valve portion that closes the drain hole openably;

a biasing portion that extends from an end portion of the valve portion and biases the valve portion in a direction for closing the drain hole; and

a latch portion that is provided on an end portion of the biasing portion and latched to a latched portion provided on the tubular body, wherein

the drain valve body is formed integrally from a plate material.
2. The drain valve body for a fluid filter according to 1. above, wherein the latch portion is latched to the latched portion in an outward orientation from a center side of the cap, and biased by a bias of the biasing portion in an outwardly-opening direction relative to the latched portion.
3. The drain valve body for a fluid filter according to 2. above, wherein the latch portion is positioned outward of a connecting location between the valve portion and the biasing portion, using a central axis of the drain hole in the cap as a reference.
4. The drain valve body for a fluid filter according to 1. above, wherein the biasing portion is bent into a V shape, and a resulting bend portion is disposed on an outer side.
5. The drain valve body for a fluid filter according to 2. above, wherein the biasing portion is bent into a V shape, and a resulting bend portion is disposed on an outer side.
6. The drain valve body for a fluid filter according to 3. above, wherein the biasing portion is bent into a V shape, and a resulting bend portion is disposed on an outer side.
7. The drain valve body for a fluid filter according to 1. above, wherein the biasing portion is bent into an arc-shaped curve, and a resulting bend portion is disposed on an outer side.
8. The drain valve body for a fluid filter according to 2. above, wherein the biasing portion is bent into an arc-shaped curve, and a resulting bend portion is disposed on an outer side.
9. The drain valve body for a fluid filter according to 3. above, wherein the biasing portion is bent into an arc-shaped curve, and a resulting bend portion is disposed on an outer side.
10. A fluid filter comprising:

a filter element;

a tubular body that supports the filter element;

a cap and a base that house the filter element and the tubular body and can be screwed together through relative rotation;

a drain cap that is attached detachably to the cap from an outer side and closes a drain hole formed in the cap; and

the drain valve body according to 1. above, which is provided between the cap and the tubular body and sandwiches the tubular body together with the base, wherein

a fluid that flows into a casing formed from a combination of the base and the cap through an inflow passage provided in the base is discharged through an outflow passage provided in the base, and

during drainage, the drain hole is opened by pushing the drain valve body to the tubular body side such that the fluid in the casing is discharged through the drain hole.
11. The fluid filter according to 10. above, wherein the latch portion is latched to the latched portion in an outward orientation from a center side of the cap, and biased by a bias of the biasing portion in an outwardly-opening direction relative to the latched portion.
12. The fluid filter according to 11. above, wherein the latch portion is positioned outward of a connecting location between the valve portion and the biasing portion, using a central axis of the drain hole in the cap as a reference.
13. The fluid filter according to 10. above, wherein the biasing portion is bent into a V shape, and a resulting bend portion is disposed on an outer side.
14. The fluid filter according to 11. above, wherein the biasing portion is bent into a V shape, and a resulting bend portion is disposed on an outer side.
15. The fluid filter according to 12. above, wherein the biasing portion is bent into a V shape, and a resulting bend portion is disposed on an outer side.
16. The fluid filter according to 10. above, wherein the drain cap is attached to the drain hole such that an upper end of the drain cap projects slightly upward of an upper end opening of the drain hole, and

the drain valve body contacts with the upper end of the drain cap such that the drain cap is biased downward when the drain cap is attached to the drain hole, and contacts with an upper end surface of the drain hole such that the drain hole is closed when the drain cap is detached from the drain hole.

[Effects of the Invention]

The drain valve body for a fluid filter according to the present invention includes the valve portion that closes the drain hole openably, the biasing portion that biases the valve portion in a direction for closing the drain hole, and the latch portion that is latched to the latched portion provided on the tubular body of the filter element, and these components are formed integrally from a plate material. Hence, the drain hole closing member and the filter element fixing member, which are provided as separate structures in the related art, are integrated, leading to a reduction in the number of components and a reduction in component costs. Furthermore, the valve portion and biasing portion can be provided in the interior of the cap through a simple operation of latching the latch portion to the latched portion of the tubular body, and therefore the assembly time can be shortened and a corresponding reduction in component costs can be achieved.

Further, when latch portion is latched to the latched portion in an outward orientation from the center side of the cap and biased by the bias of the biasing portion in an outwardly-opening direction relative to the latched portion, the latch portion is not simply latched to the latched portion, but also pushed in a direction for opening the latched portion outward, and therefore the latching force can be increased and the filter element can be held in the interior of the casing with stability.

Further, when the latch portion is positioned outward of the connecting location between the valve portion and the biasing portion, using the central axis of the drain hole in the cap as a reference, an outwardly-rotating moment is generated about the connecting location between the valve portion and the biasing portion, and thus the latch portion can be biased reliably in a direction for opening the latched portion outward. As a result, the drain valve body can hold the filter element inside the casing with even more stability.

Further, when the biasing portion is bent into a V shape and the resulting bend portion is disposed on the outside, the biasing portion can be formed more easily and is capable of exhibiting biasing force through smooth elastic deformation.

The fluid filter of the present invention includes the drain valve body described above, and therefore exhibits similar effects to those of each aforementioned drain valve body.

### BRIEF DESCRIPTION OF THE DRAWINGS

FIG. 1 is a sectional view of an oil filter according to an embodiment;

FIG. 2 is a perspective view of a drain valve body shown in FIG. 1;

FIG. 3 is a perspective view of a plate shown in FIG. 1;

FIG. 4 is a perspective view of a state in which the drain valve body of FIG. 2 is attached to the plate of FIG. 3;

FIG. 5 is an illustrative view showing in pattern form a procedure for attaching the drain valve body of FIG. 2 to the plate of FIG. 3;

FIG. 6 is a sectional view showing a procedure for detaching a drain bolt when discharging oil from the oil filter shown in FIG. 1, 6A showing a state of normal use, 6B showing a state in which the drain bolt is loosened, and 6C showing a state in which the drain bolt is detached;

FIG. 7 is a sectional view showing a state in which oil is discharged from the oil filter of FIG. 1 using a drain jig;

FIG. 8 is a sectional view showing a modified example of the oil filter according to the present invention; and

FIG. 9 shows another drain valve body of the present invention, 9A being a perspective view, and 9B and 9C being sectional views.

### DESCRIPTION OF REFERENCE NUMERALS AND SIGNS

1; oil filter, 2; base, 3; cap, 4; casing, 12; plate, 12b; latched portion, 15; drain hole, 17; drain bolt (drain cap), 21; drain valve body, 22; valve portion, 25; biasing portion, 26; bend portion, 29; latch portion, 51; filter element, 52; tubular body, 61; inflow passage and 62; outflow passage.

### DETAILED DESCRIPTION OF THE PREFERRED EMBODIMENTS

A fluid filter and a drain valve body thereof according to the present invention will now be described in detail.

For example, a fluid filter of the present invention has a filter element, a tubular body for supporting the filter element, a cap and a base that house the filter element and tubular body and can be screwed together through relative rotation, a drain cap that is attached to the cap detachably from the outer side and closes a drain hole formed in the cap, and a drain valve body that is provided between the cap and the tubular body and sandwiches the tubular body together with the base.

For example, the drain valve body of the present invention has a valve portion that closes the drain hole openably, a biasing portion that extends from an end portion of the valve portion and biases the valve portion in a direction for closing the drain hole, and a latch portion that is provided on an end portion of the biasing portion and latched to a latched portion provided on the tubular body.

The fluid filter according to this embodiment may be used to filter an arbitrary fluid such as oil for lubricating an internal combustion engine or the like.

The aforementioned “filter element” is a member for filtering a fluid by causing the fluid to pass from an outer peripheral side to a central axis portion, and there are no particular limitations on the material and structure thereof. Further, the filter element is a tubular body, but the respective shapes of the outer peripheral side and inner peripheral side may be the same or different. Moreover, as long as one end surface of the central axis portion is open, the other end surface may be open or closed.

The shape of the aforementioned “tubular body” may be selected arbitrarily. For example, a cylindrical shape having large number of through holes and penetrating the central axis portion of the filter element may be employed. Further, examples of the material for the tubular body include metal and synthetic resin.

There are no particular limitations on the structure, shape, material and so on of the aforementioned “cap” as long as it is engaged to the base and includes the drain hole. Examples of a mechanism for engaging the cap and base include a screw mechanism constituted by male and female screw portions that can be screwed together, and a bayonet mechanism constituted by a groove portion and a projecting portion that can be engaged and disengaged.

Further, the aforementioned “base” is typically formed with an inflow passage through which fluid flows into the interior of a casing from the outside, and an outflow passage for discharging the fluid to the outside, for example. There are no particular limitations on the shape, size, number and so on of the “inflow passage” as long as it is provided in the base. For example, the inflow passage may be disposed at appropriate radial intervals about the tubular body. A check valve may be provided in an opening portion of the inflow passage. Further, the inflow passage communicates with an oil pump, for example. There are no particular limitations on the shape, size, number and so on of the “outflow passage” as long as it is provided in the base and opens toward the interior of the casing. The outflow passage communicates with an engine lubrication portion, for example.

There are no particular limitations on the structure, shape, material and so on of the aforementioned “drain cap” as long as it is attached to the cap detachably from the outer side and is capable of closing the drain hole. For example, the drain cap may be constituted by a drain bolt formed with a male screw that can be screwed to a female screw formed in the inner peripheral surface of the drain hole.

Note that typically, for example, a sealing member such as an O ring may be provided between the drain cap and the cap.

The aforementioned “drain valve body” is manufactured by forming the valve portion, the biasing portion, and the latch portion integrally using a plate material. Further, a metal plate, a synthetic resin plate, or another plate that can be used as a plate spring, a disc spring and so on may be employed as the plate material. Moreover, the molding method of the drain valve body may be selected arbitrarily, and the drain valve body may be formed integrally by press molding or the like, for example.

There are no particular limitations on the structure, shape and so on of the aforementioned “valve portion” as long as it is capable of closing the drain hole from the inside of the casing. For example, the valve portion may close the drain hole by coming into contact with a valve seat portion provided in the cap. Further, the drain hole may be sealed by contact between the valve portion and valve seat portion directly or indirectly via the sealing member.

There are no particular limitations on the structure, shape and so on of the aforementioned “biasing portion” as long as it is formed integrally with the valve portion and capable of biasing the valve portion in a direction for closing the drain hole.

For example, the biasing portion may be formed by having a plurality of elongated rectangular plates extend from the end portion of the valve portion. Further, the elongated rectangular plate may be bent into a V shape. The biasing portion may also be formed by connecting a disc spring, a spiral spring or the like to a peripheral edge of the valve portion and having a plurality of elongated rectangular plates extend from the end portion of the disc spring or the like. The biasing portion may also be formed in the shape of an arc-shaped plate. Note that the biasing portion may also have functions to bias and support the filter element and the tubular body for supporting the filter element, for example.

There are no particular limitations on the structure, shape and so on of the aforementioned “latch portion” as long as it is formed integrally with the valve portion and the biasing portion and can be latched to the latched portion provided on the tubular body. The latch portion is provided on the end portion of the biasing portion. In other words, the valve portion, the biasing portion, and the latch portion are provided in that order. The latched portion may be provided on the tubular body for supporting the filter element. Further, when the tubular body is provided with a plate or the like, the latched portion may be provided on the plate.

There are no limitations on the number of latch portions as long as it can grip the tubular body, and hence the latch portion may be provided in an arbitrary number. For example, a pair of opposing latch portions may be provided, or three or more latch portions may be provided. When three or more latch portions are provided, the stability with which the tubular body is held improves.

The latch portion is preferably latched to the latched portion inside the cap in an outward orientation from a center side of the cap such that the latched portion in the cap interior is biased in an outwardly-opening direction by the biasing force of the biasing portion. In so doing, the latching force can be increased and the drain valve body can be held in the interior of the cap with stability. More specifically, when the latch portion is disposed on the outside of a connecting location between the valve portion and biasing portion, using a central axis of the drain hole in the cap as a reference, for example, an outwardly-rotating moment is generated about the connecting location between the biasing portion and valve portion, and as a result, the latched portion is biased in an outwardly-opening direction.

### Embodiment

An embodiment of the fluid filter and drain valve body of the present invention will now be described specifically using the drawings. This embodiment relates to an oil filter that uses oil for lubricating an engine of a vehicle or the like as a fluid, and a drain valve body thereof.

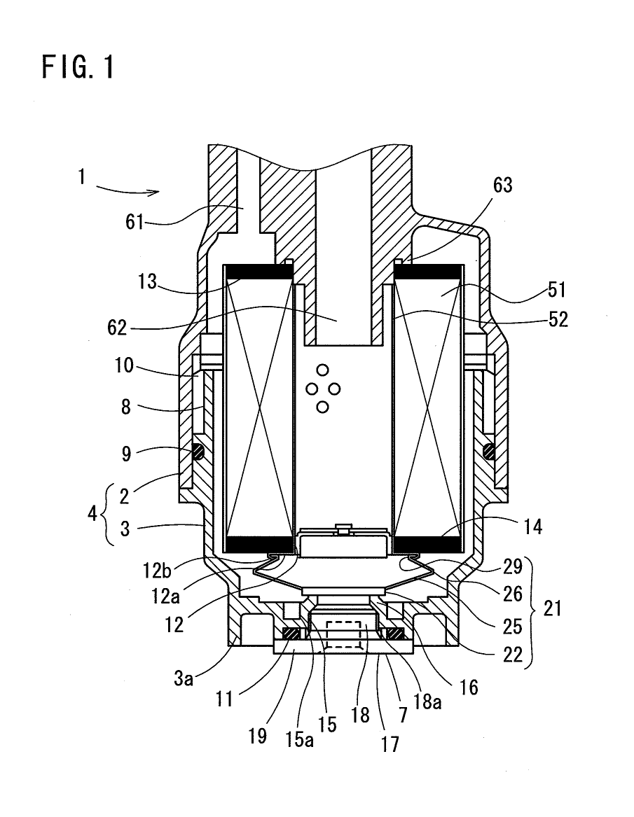

As shown in FIG. 1, an oil filter 1 according to this embodiment has a filter element 51, a tubular body 52 that penetrates and supports the filter element 51, a base 2 and a cap 3 that are made of metal and can be engaged to and disengaged from each other, a metallic drain bolt 17 serving as a drain cap provided on the cap 3, and a drain valve body 21 provided between the cap 3 and the tubular body 52.

The base 2 has an inflow passage 61 and an outflow passage 62 that open into the interior of the casing 4.

An outer peripheral surface of the cap 3 is formed with a male screw portion 8, and an O ring 9 is attached thereto. Further, an inner peripheral surface of the base 2 is formed with a female screw portion 10. When the base 2 and cap 3 are engaged to each other via the O ring 9 by screwing together the male screw portion 8 and female screw portion 10, the interior of the casing 4 is held in a fluid-tight state. In other words, an end portion of the filter element 51 is pressed against and sealed to a plate 12 via a sealing material 14 by the biasing force of a biasing portion 25 of the drain valve body 21. Similarly, the end portion of the filter element 51 is pressed against and sealed to a base projecting portion 63 provided on the base 2 via a sealing material 13 by the biasing force of the biasing portion 25.

Oil flows into the casing 4 of the oil filter 1 constituted in this manner through the inflow passage 61 and is then filtered as it passes from the outer peripheral side to the inner peripheral side of the filter element 51. The oil is then discharged to the exterior of the casing 4 through the outflow passage 62.

Further, a drain hole 15 formed with a female screw 15a on its inner periphery is formed in the center of a bottom portion 3a of the cap 3. An O ring 11 is attached to a lower end portion of the bottom portion 3a of the cap 3 so as to surround the drain hole 15. Further, a ring-shaped cap projecting portion 16 is provided on an upper end portion of the bottom portion 3a of the cap 3.

A drain bolt 17 and the drain valve body 21 function as a drain mechanism 7. The drain bolt 17 includes a plug portion 18 formed with a male screw 18a, and a flange portion 19 formed continuously from a lower portion of the plug portion 18. When the drain bolt 17 is bolted to the drain hole 15 by screwing together the male screw 18a of the drain bolt 17 and the female screw 15a of the drain hole 15, the flange portion 19 of the drain bolt 17 is pressed against the O ring 11, thereby sealing the drain hole 15.

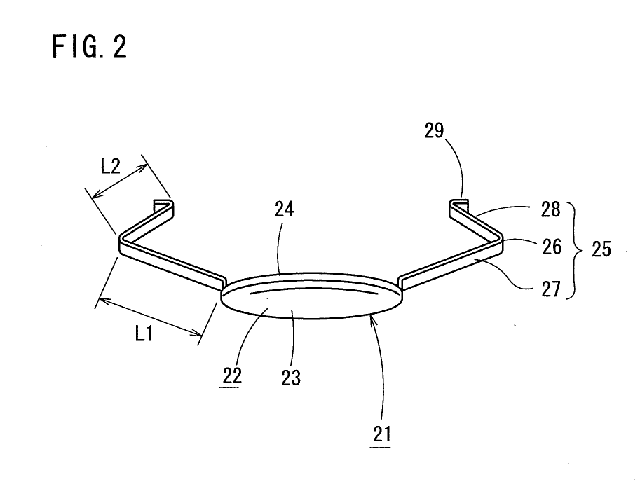

As shown in FIG. 2, the drain valve body 21 is constituted by a valve portion 22 that closes the drain hole 15 openably, the biasing portion 25, which extends from an end portion of the valve portion 22 and biases the valve portion 22 in a direction for closing the drain hole 15, and a latch portion 29 that is provided on a free end portion of the biasing portion 25 and latched to a latched portion 12b provided on the plate 12 inside the cap 3. These components are formed integrally by press-molding a plate material made of spring steel.

The valve portion 22 of the drain valve body 21 is formed in the shape of a catch pan in which a ring-shaped flange 24 stands upright on the peripheral edge portion of a disc-shaped bottom surface 23. The bottom surface 23 is usually held in contact with an upper surface of the cap projecting portion 16 by the biasing force of the biasing portion 25, thereby closing the drain hole 15. Therefore, even when the drain bolt 17 is detached from the drain hole 15, discharge of the oil in the casing 4 through the drain hole 15 is restricted as long as the drain valve body 21 closes the drain hole 15.

The biasing portion 25 is formed by bending an elongated rectangular plate into a substantially V-shaped form at a bend portion 26, and is provided in an opposing pair on an upper end surface of the flange 24 of the valve portion 22 in positions removed from each other by 180 degrees. The respective biasing portions 25 extend outward and diagonally upward from the upper end surface of the flange 24 of the valve portion 22. Accordingly, the bend portion 26 is positioned on the outside of the valve portion 22. Further, in the biasing portion 25, a length L1 of a base end side arm portion 27, i.e. the part that extends from a connecting location with the upper end surface of the flange 24 of the valve portion 22 to the bend portion 26, is formed to be greater than a length L2 of a free end side arm portion 28, i.e. the part that inverts at the bend portion 26 and extends to the free end side. Thus, the latch portion 29 formed on the free end side of the biasing portion 25 is positioned on the outside of the connecting location between the valve portion 22 and biasing portion 25, or in other words the base end portion of the biasing portion 25, using a central axis of the drain hole 15 in the cap 3 as a reference.

The biasing portion 25 deforms in an up-down direction using the connecting location with the upper end surface of the flange 24 of the valve portion 22 and the bend portion 26 as fulcrums such that when the drain valve body 21 is incorporated into the interior of the cap 3, the valve portion 22 is biased in a direction for closing the drain hole 15. Note that the width of the biasing portion 25 is formed to be constant in the length direction, but may be varied appropriately in the length direction. Furthermore, in this embodiment, the biasing portion 25 is provided in an opposing pair, but the present invention is not limited thereto, and three or more biasing portions may be provided. When three or more biasing portions are provided, a slight reduction in ease of assembly occurs, but the stability with which the drain valve body 21 is held on the plate 12 increases.

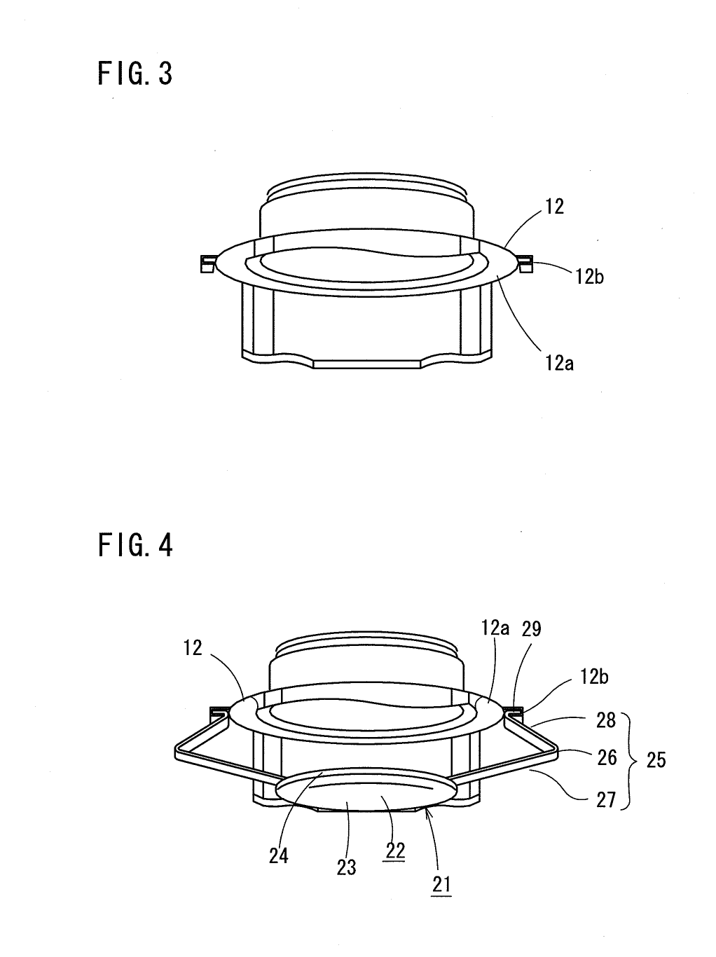

The latch portion 29 is provided on the free end side of the biasing portion 25 and formed by folding back the free end of the biasing portion 25 in a horizontal direction. The latch portion 29 is latched to a pair of latched portions 12b formed as U-shaped bends projecting from the peripheral edge of a ring-shaped collar portion 12a of the plate 12 provided in the cap 3, as shown in FIGS. 1 and 3. FIG. 4 shows a state in which the latch portions 29 are inserted in and latched to the latched portions 12b of the plate 12. Note that the latched portion 12b of the plate 12 is preferably provided with a shielding plate or the like on either side to prevent the latch portion 29 from becoming dislodged.

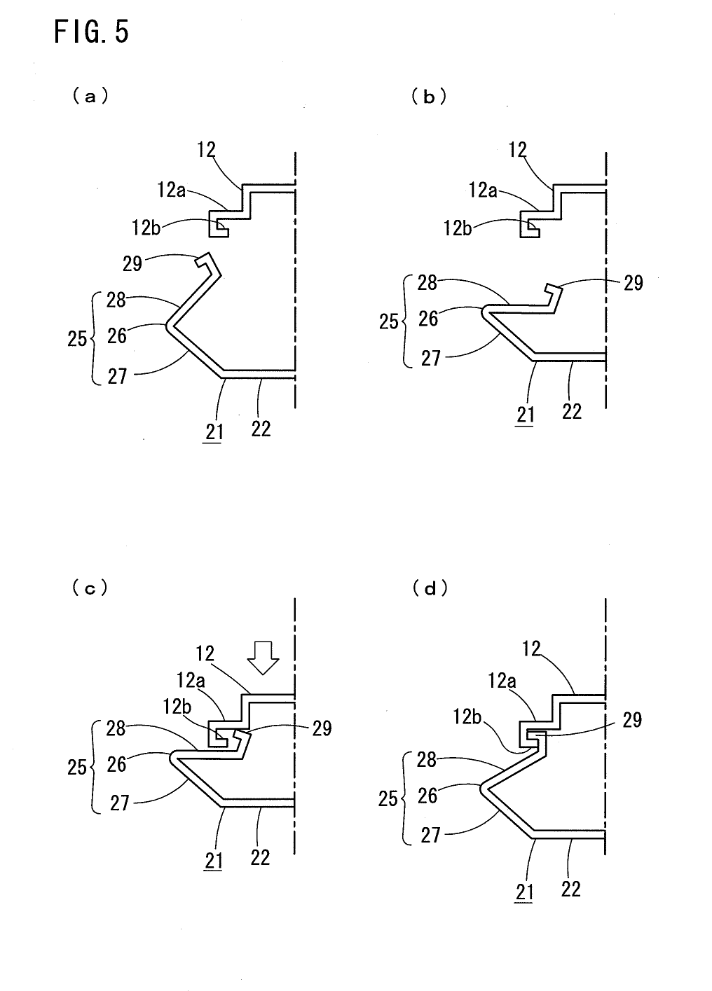

Next, a method of disposing the drain valve body 21 constituted in this manner in the cap 3 of the oil filter 1 will be described on the basis of FIG. 5.

First, as shown in FIG. 5A, the drain valve body 21 is disposed beneath the plate 12. Next, as shown in FIG. 5B, the free end side arm portion 28 of the biasing portion 25 is deformed downward by bending the free end side arm portion 28 about the bend portion 26, and while maintaining this state, the plate 12 is moved downward and pressed against the free end side arm portion 28, as shown in FIG. 5C. When the plate 12 reaches a latchable position, the pressing is released. Hence, as shown in FIG. 5D, the biasing portion 25 returns to its original inclined state under its own elastic restoring force, whereby the latch portion 29 is latched naturally to the latched portion 12b of the plate 12 while applying a biasing force to the latched portion 12b that causes the latched portion 12b to open out in the leftward direction of FIG. 5. Thus, the drain valve body 21 can be attached to the plate 12 easily, and since the latch portion 29 latches the latched portion 12b of the plate 12 while biasing the latched portion 12 in an outwardly opening direction, the engaging force with the latched portion 12b is strengthened such that the drain valve body 21 is held on the plate 12 with stability.

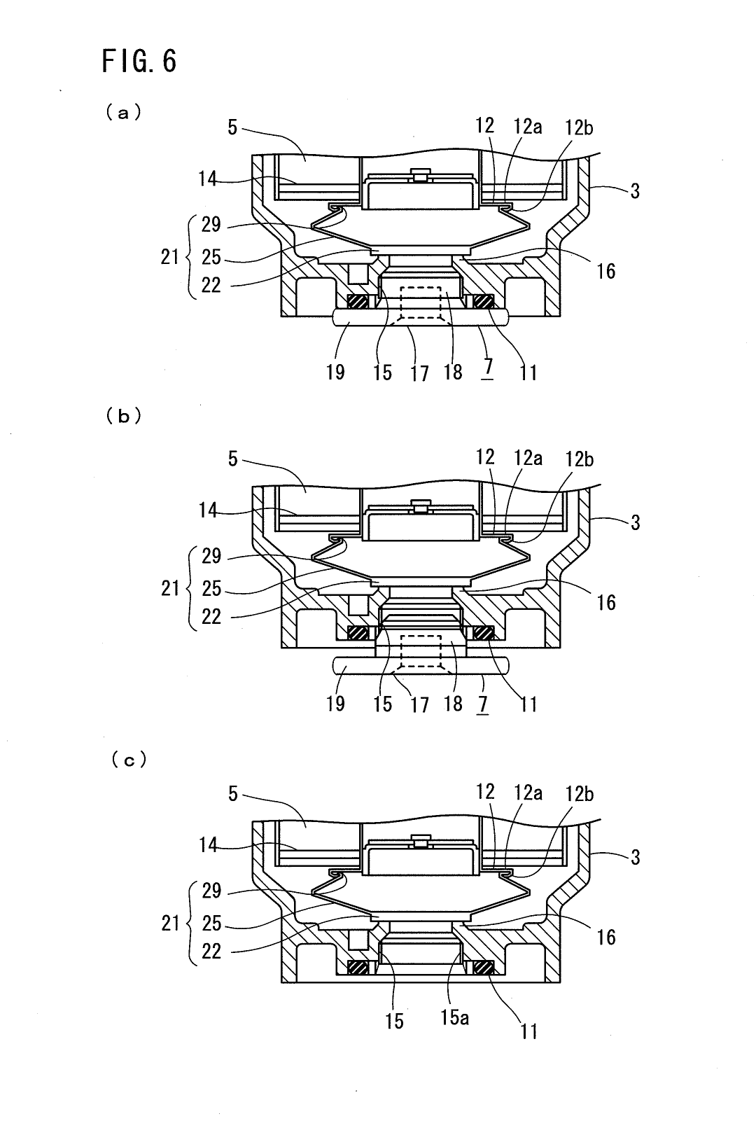

Next, a method of discharging oil from the oil filter 1 to replace the filter element 51, O ring 9, O ring 11 and so on will be described on the basis of FIG. 6.

During normal use, as shown in FIG. 6A, the drain bolt 17 is attached to the drain hole 15 from the lower outer side of the oil filter 1 by screwing together the male screw 18a and the female screw 15a. At this time, the bottom surface 23 of the valve portion 22 on the drain valve body 21 is held in contact with the upper end surface of the cap projecting portion 16 by the biasing force of the biasing portion 25, and as a result, the drain hole 15 is closed. Further, the upper surface of the flange portion 19 of the drain bolt 17 is pressed against the O ring 11 mounted on the periphery of the drain hole 15. Hence, during normal use, the drain hole 15 is sealed via the O ring 11 through attachment of the drain bolt 17 and closed by the drain valve body 21, and therefore the interior of the oil filter 1 is completely blocked from the outside. Accordingly, the oil in the oil filter 1 does not leak to the outside.

When the drain bolt 17 is loosened and moved downward from this state, as shown in FIG. 6B, the flange portion 19 of the drain bolt 17 separates from the O ring 11 mounted on the periphery of the drain hole 15. However, in this state, the bottom surface 23 of the valve portion 22 on the drain valve body 21 continues to be held in contact with the upper end surface of the cap projecting portion 16 by the biasing force of the biasing portion 25, and therefore the drain hole 15 remains closed. Accordingly, the oil in the oil filter 1 is not discharged through the drain hole 15, and even if it is, the amount of discharged oil is extremely small. Hence, a situation in which the oil spills through the gap between the base 2 and the cap 3 when the drain bolt 17 is detached, thereby contaminating the surrounding area, can be avoided.

Next, as shown in FIG. 6C, the drain bolt is loosened further and detached. Note that in this state also, contact is maintained between the valve portion 22 of the drain valve body 21 and the cap projecting portion 16, and therefore, similarly to FIG. 6B, no oil is discharged through the drain hole 15, and even if oil discharge occurs, the amount of leakage remains extremely small.

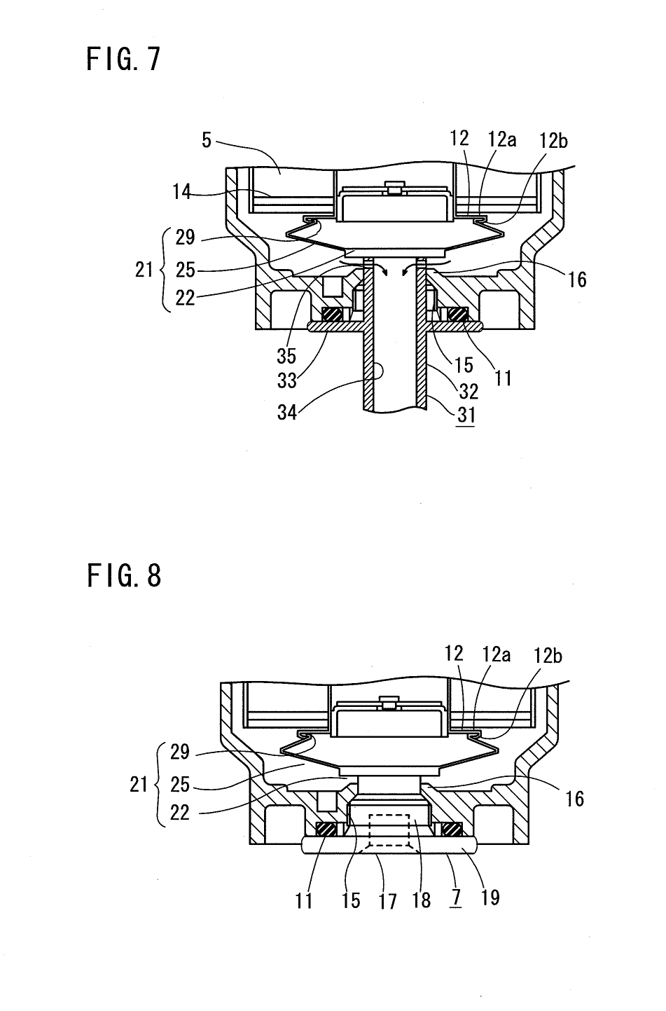

Once the drain bolt 17 has been detached in the manner described above, the oil is discharged from the lower outer side of the drain hole 15 using a drain jig 31, as shown in FIG. 7.

As shown in FIG. 7, the drain jig 31 is made of metal or synthetic resin, and has an overall tubular shape. The drain jig 31 includes a pipe-shaped portion 32, both ends of which are open, and a catch pan-shaped flange portion 33 provided in an intermediate portion of the pipe-shaped portion 32. A through hole 35 that communicates with an internal passage 34 is formed in the upper end portion of the pipe-shaped portion 32. Further, when the drain jig 31 is fixed to the cap 3, the flange portion 33 of the drain jig 31 is pressed against and sealed by the O ring 11 of the cap 3.

The drain jig 31 is inserted into the drain hole 15 such that the drain valve body 21 is pushed upward by the upper end surface thereof against the biasing force of the biasing portion 25. As a result, the valve portion 22 of the drain valve body 21 no longer closes the drain hole 15, and the residual oil in the casing 4 is discharged to the outside through the through hole 35 in the drain jig 31. At this time, the flange portion 33 of the drain jig 31 is pressed against the O ring 11 provided on the bottom portion 3a of the cap 3.

Once the residual oil has been discharged from the interior of the casing 4, the drain jig 31 is withdrawn from the cap 3. As a result, the oil in the oil filter 1 is discharged. Note that thereafter, a detachment jig not shown in the drawing is used to loosen the cap 3 so as to separate the cap 3 from the base 2, whereupon an operation to replace the filter element 51, the O ring 9, the O ring 11 and so on is performed.

Next, actions of the drain valve body 21 of the oil filter 1 according to this embodiment, constituted as described above, will be described.

The drain valve body 21 includes the valve portion 22 that closes the drain hole 15 openably, the biasing portion 25 that biases the valve portion 22 in a direction for closing the drain hole 15, and the latch portion 29 that is latched to the latched portion 12b provided on the plate 12 inside the cap 3, and these components are formed integrally. Hence, the closing member for closing the drain hole 15 and the biasing member for biasing the valve portion 22 in a direction for closing the drain hole 15, which are provided as separate structures in the related art, are integrated, leading to a reduction in the number of components and a reduction in component costs. Furthermore, the latch portion 29 can be elastically latched to the latched portion 12b of the plate 12 through a simple operation of pressing the drain valve body 21 and the plate 12 against each other while deforming the biasing portion 25, and therefore the drain valve body 21 can be attached to the plate 12 easily and the attachment time can be reduced.

Further, by bending the biasing portion 25 into a V shape, disposing the resulting bend portion 26 on the outside, and forming the latch portion 29 on the free end side of the biasing portion 25, the latch portion 29 is positioned on the outside of the connecting location between the valve portion 22 and the biasing portion 25, or in other words the base end portion of the biasing portion 25, using the central axis of the drain hole 15 in the cap 3 as a reference. In other words, the latch portion 29 is positioned on the outside of a vertical line passing through the connecting location in FIGS. 1, 6 and so on, and latched to the latched portion 12b of the plate 12 in an outward orientation from the central side of the cap 3. Hence, when the drain valve body 21 is assembled in the cap 3, an outwardly rotating moment is generated in the latch portion 29 by the biasing force of the biasing portion 25 about the connecting location between the biasing portion 25 and the valve portion 22, and therefore the latch portion 29 is biased in an outwardly-opening direction relative to the latched portion 12b of the plate 12. As a result, the latching force between the latch portion 29 and the latched portion 12b of the plate 12 increases such that the drain valve body 21 is fixed to the plate 12 with stability.

Thus, the biasing force of the biasing portion 25 acts in two directions, exhibiting a function for closing the drain hole 15 by having the valve portion 22 contact the cap projecting portion 16 and a function for contributing to a stable latch state by biasing the latch portion 29 horizontally outward relative to the latched portion 12b of the plate 12.

Moreover, since the biasing portion 25 is bent into a V shape and the latch portion 29 is formed by simply folding back the free end portion of the biasing portion 25 in a horizontal direction, the biasing portion 25 biases the valve portion 22 through smooth elastic deformation and the drain valve body 21 has a simple constitution.

During replacement of the filter element 51 and so on, the drain jig 31 is used to discharge the residual oil before separating the base 2 from the cap 3, and therefore a situation in which the oil spills out of the casing 4 when the base 2 and cap 3 are completely separated, thereby contaminating the surrounding area, can be avoided.

Incidentally, in this embodiment the drain valve body 21 closes the drain hole 15 when the bottom surface 23 of the valve portion 22 comes into contact with the cap projecting portion 16. However, as shown in FIG. 8, the drain bolt 17 may be attached such that its upper end projects slightly upward of the upper end opening of the drain hole 15. During normal use, the drain bolt 17 may become loose as a result of vehicle vibration or the like, leading to a reduction in the sealing performance of the O ring 11 and possible oil leakage. In this case, however, the valve portion 22 of the drain valve body 21 contacts the tip end surface of the drain bolt 17 such that the drain bolt 17 is pushed downward by the biasing force of the biasing portion 25, and therefore loosening of the drain bolt 17 can be prevented, and an improvement in the sealing performance of the O ring 11 can be achieved.

(Miscellaneous)

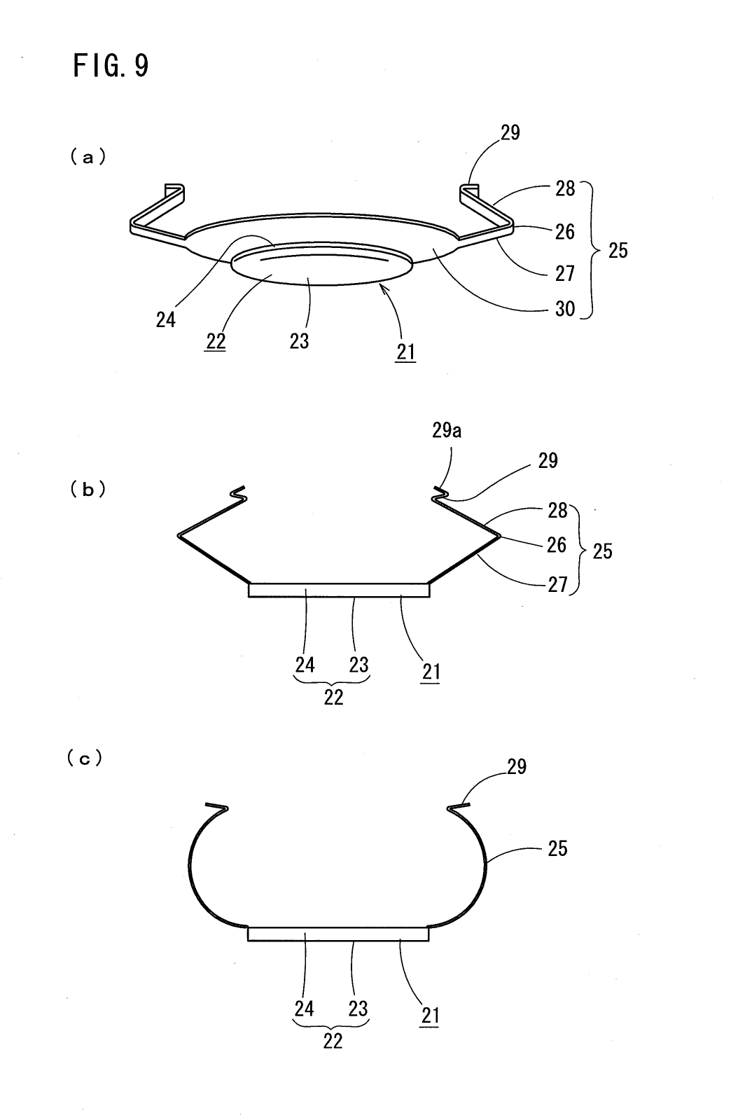

In this embodiment, the drain valve body 21 is structured such that the biasing portion 25, which is formed by bending an elongated rectangular plate into a V shape, is integrated with the catch pan-shaped valve portion 22, but when the present invention is implemented, the drain valve body 21 is not limited to this structure, and as shown in FIG. 9A, for example, the drain valve body 21 may be formed such that a disc spring 30 is provided integrally between the catch pan-shaped valve portion 22 and the V-shaped base end side arm portion 27, and the biasing portion 25 is constituted by a combination of the V-shaped base end side arm portion 27, the free end side arm portion 28, and the disc spring 30. In this case, a two-stage biasing structure is provided, and therefore the biasing force of the biasing portion 25 can be adjusted easily.

Further, as shown in FIG. 9B, a folded-back portion 29a that is folded back toward the inside and diagonally upward may be formed on the tip end of the latch portion 29 of the drain valve body 21 in the embodiments described above. In this case, the tip end of the folded-back portion 29a of the latch portion 29 contacts an inner wall of the latched portion 12b of the plate 12 such that the latch portion 29 is less likely to become dislodged from the latched portion 12b.

Furthermore, the biasing portion 25 of the drain valve body 21 is formed by bending an elongated rectangular plate into a V shape, but the biasing portion 25 is not limited to this structure, and may be formed by bending an elongated rectangular plate into an arc-shaped curve, as shown in FIG. 9C. Alternatively, the biasing portion 25 may employ a coil spring formed in a spiral shape resembling a mosquito coil, be formed in a combination of a V shape and a spiral shape, or be formed in an accordion shape.

Note that in the embodiments described above, oil for lubricating the engine of a vehicle or the like is used as an example of a fluid, and the oil filter 1 is used as an example of a fluid filter, but upon implementation, the present invention is not limited to these examples.

What is claimed is:

1. A drain valve body for a fluid filter, provided in a fluid filter having a filter element, a tubular body that supports said filter element, a cap and a base that house said filter element and said tubular body and can be screwed together through relative rotation, and a drain cap that is attached detachably to said cap from an outer side and closes a drain hole formed in said cap, said drain valve body comprising:
a valve portion that closes said drain hole openably;
a biasing portion that extends from an end portion of said valve portion and biases said valve portion in a direction for closing said drain hole; and
a latch portion that is provided on an end portion of said biasing portion and latched to a latched portion provided on said tubular body, wherein
said drain valve body is formed integrally from a plate material.

2. The drain valve body for a fluid filter according to claim 1, wherein said latch portion is latched to said latched portion in an outward orientation from a center side of said cap, and biased by a bias of said biasing portion in an outwardly-opening direction relative to said latched portion.

3. The drain valve body for a fluid filter according to claim 2, wherein said latch portion is positioned outward of a connecting location between said valve portion and said biasing portion, using a central axis of said drain hole in said cap as a reference.

4. The drain valve body for a fluid filter according to claim 1, wherein said biasing portion is bent into a V shape, and a resulting bend portion is disposed on an outer side.

5. The drain valve body for a fluid filter according to claim 2, wherein said biasing portion is bent into a V shape, and a resulting bend portion is disposed on an outer side.

6. The drain valve body for a fluid filter according to claim 3, wherein said biasing portion is bent into a V shape, and a resulting bend portion is disposed on an outer side.

7. The drain valve body for a fluid filter according to claim 1, wherein said biasing portion is bent into an arc-shaped curve, and a resulting bend portion is disposed on an outer side.

8. The drain valve body for a fluid filter according to claim 2, wherein said biasing portion is bent into an arc-shaped curve, and a resulting bend portion is disposed on an outer side.

9. The drain valve body for a fluid filter according to claim 3, wherein said biasing portion is bent into an arc-shaped curve, and a resulting bend portion is disposed on an outer side.

10. A fluid filter comprising:
a filter element;
a tubular body that supports said filter element;
a cap and a base that house said filter element and said tubular body and can be screwed together through relative rotation;
a drain cap that is attached detachably to said cap from an outer side and closes a drain hole formed in said cap; and
the drain valve body according to claim 1, which is provided between said cap and said tubular body and sandwiches said tubular body together with said base, wherein
a fluid that flows into a casing formed from a combination of said base and said cap through an inflow passage provided in said base is discharged through an outflow passage provided in said base, and
during drainage, said drain hole is opened by pushing said drain valve body to said tubular body side such that said fluid in said casing is discharged through said drain hole.

11. The fluid filter according to claim 10, wherein said latch portion is latched to said latched portion in an outward orientation from a center side of said cap, and biased by a bias of said biasing portion in an outwardly-opening direction relative to said latched portion.

12. The fluid filter according to claim 11, wherein said latch portion is positioned outward of a connecting location between said valve portion and said biasing portion, using a central axis of said drain hole in said cap as a reference.

13. The fluid filter according to claim 10, wherein said biasing portion is bent into a V shape, and a resulting bend portion is disposed on an outer side.

14. The fluid filter according to claim 11, wherein said biasing portion is bent into a V shape, and a resulting bend portion is disposed on an outer side.

15. The fluid filter according to claim 12, wherein said biasing portion is bent into a V shape, and a resulting bend portion is disposed on an outer side.

16. The fluid filter according to claim 10, wherein said drain cap is attached to said drain hole such that an upper end of said drain cap projects slightly upward of an upper end opening of said drain hole, and
said drain valve body contacts with said upper end of said drain cap such that said drain cap is biased downward when said drain cap is attached to said drain hole, and contacts with an upper end surface of said drain hole such that said drain hole is closed when said drain cap is detached from said drain hole.
